(19) United States
(12) Patent Application Publication
(10) Pub. No.: US 2008/0202950 A1
(43) Pub. Date: Aug. 28, 2008

(54) CONTAINER CAP HAVING DISPENSING STORAGE CHAMBER

(76) Inventor: Michael R. Anderson, Boca Raton, FL (US)

Correspondence Address: MALIN HALEY AND DIMAGGIO, PA, 1936 S ANDREWS AVENUE, FORT LAUDERDALE, FL, 33316, US

(21) Appl. No.: 12/036,539

(22) Filed: Feb. 25, 2008

Related U.S. Application Data
(60) Provisional application No. 60/891,735, filed on Feb. 27, 2007.

(51) Int. Cl. B65D 25/08; A61J 11/00

(52) U.S. Cl. 206/219; 215/11.1; 206/222

(57) ABSTRACT

A small storage chamber for manually dispensing a liquid or powder substance into a primary container at the time of use to increase shelf life of combined substances. The storage chamber is mountable in a primary container opening or can include a threaded cap fastener. An actuator is movably mounted to said storage chamber and may include an aperture that allows for rapid filling of the storage chamber at the factory.

### BACKGROUND OF THE INVENTION

1. Field of the Invention

This invention relates generally to a bottle or container cap that is threadably secured to the container for closure that includes a small storage chamber to hold a second ingredient that can be dispensed into the bottle or container when desired.

2. Description of Related Art

The use of caps for dispensing a second chemical or liquid into a first liquid is known in the prior art. This was accomplished using a completely separate container that would be inserted into the neck of a bottle. The present invention provides a unified cap that includes a threaded connector portion that is molded with a storage chamber so that the cap and storage chamber function as a single unit for dispensing a second ingredient into the container.

### SUMMARY OF THE INVENTION

A cap that can house a separate substance for dispensing one or more ingredients into a container or receptacle such as a bottle, pouch or bag. The cap body includes a storage chamber having a frangible base that includes a plunging tube connected thereto.

The cap body also includes an exterior peripheral rim that in one embodiment would include threads for fastening the cap body to a threaded receptacle such as a bottle neck.

The dispensing cap has a circular top opening that receives a movable cylindrically shaped plunger that engages the plunging tube when manually depressed downwardly forcing the bottom of the storage compaitnent to tear open allowing the contents to be dispensed.

The cap storage compartment for the substance to be admixed is basically a cylinder with a frangible floor that is integrally molded with the cap rim that fastens to the container.

The dispensing cap has two individual parts. The cap body includes the bottle cap fastening threads and the storage compartment. The movable plunger is used for dispensing a substance contained in the storage compartment.

The cap body substance storage compartment is an integrally molded plastic cylinder that includes an elongated vertical plunger tube connected to the bottom inside floor of the storage compartment that extends vertically up to the top of the cap body for ultimate engagement with actuating plunger.

The primary container is a plastic bottle, pouch or bag that is filled with a first substance or liquid. The second substance disposed in the cap storage compartment is dispensed at the time of use. The admixture can then be consumed by the user after the cap is removed from the bottle.

In one embodiment in addition to the cap body with the substance storage compartment and the threaded peripheral rim for attaching the cap body to a threaded bottle neck opening and the actuating plunger which is movably connected into the cap body, a sealing film or foil layer can be glued over the top of the top cap and the plunger for sealing purposes. This foil cover could be glued and also include a tab for easy removal prior to use in dispensing of the second substance.

It is an object of this invention to provide a storage and dispensing cap for a second substance that will be ultimately admixed with a first substance in a primary container to increase the effective shelf life of the overall product when mixed together.

In is another object of this invention to provide a threaded container cap for closure such as a bottle cap that has integrally molded therewith a storage compartment for a separate second substance to be dispensed into primary container at the time of use for extending product shelf life.

In accordance with these and other objects which will become apparent hereinafter, the instant invention will now be described with particular reference to the accompanying drawings.

### BRIEF DESCRIPTION OF THE DRAWINGS

FIG. 1 shows an exploded perspective view of one embodiment of the present invention.

FIG. 2 shows a side elevational view exploded of the embodiment shown in FIG. 1.

FIG. 3 shows a side elevational exploded view of an alternate embodiment of the invention.

FIG. 4 shows an exploded perspective view of the alternate embodiment of the invention shown in FIG. 3.

FIG. 5 shows yet another alternate embodiment of the invention in a perspective exploded view.

FIG. 6 shows a side elevational view in cross section of an alternate embodiment of the invention that includes a hemispherical flexible actuator.

FIG. 7 shows the embodiment of FIG. 6 in an exploded perspective view.

FIG. 8 shows a perspective exploded view of yet another alternate embodiment of the invention.

FIG. 9 is yet another alternate embodiment of the invention in an exploded perspective view.

FIG. 10 is yet another alternate embodiment of the invention in a perspective exploded view.

FIG. 11 shows a perspective view of a cap that can be used to pour a dispensing product from the container.

FIG. 12 shows a side elevational view partially in cross section of an alternate embodiment of the invention used with a collapsible or expandable container having two bottle necks.

FIG. 13 shows a side elevational view partially in cross section of an alternate embodiment of the device shown in FIG. 12.

FIG. 14 shows a side elevational view partially in cross section of an alternate embodiment of the device shown in FIGS. 12 and 13.

FIG. 15 shows yet another embodiment of the invention in a side elevational view partially in cross section.

FIG. 16 shows yet another alternate embodiment of the invention is a perspective exploded view.

FIG. 17 shows a side elevational view in cross section of the embodiment shown in FIG. 16.

### DETAILED DESCRIPTION

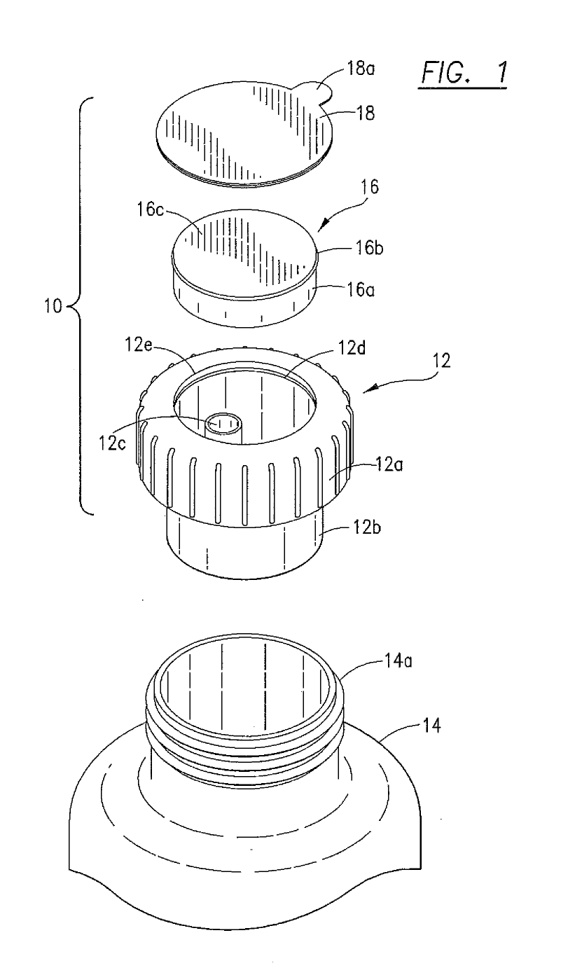

Referring now to FIG. 1, a primary container cap 12 is shown that threadably covers a plastic bottle 14 and that includes a storage chamber 12b that is cylindrical in shape. The cap 12 includes an integrally molded annular threaded cap body 12a that includes upper circular opening 12e. Visible inside storage chamber 12b is a plunger tube 12c that is connected vertically to the floor of the storage chamber 12b. The plunger 12c is mounted vertically and connected at its base and unitarily molded with the floor of storage chamber 12b. The cap body opening 12e includes a circumferential or circular groove 12d that in the closed position engages a plunger actuator 16 which includes a raised bead or raised protrusion 16b that is shaped to snuggly fit in groove 12d, scaling the cap body and the contents inside storage container 12b. A sealing foil 18 having a tab 18a for easy removal may be adhesively attached to the top of cap body 12a covering the actuator 16 and the opening 12e of cap body 12a. A substance is placed in the storage container 12b at the factory.

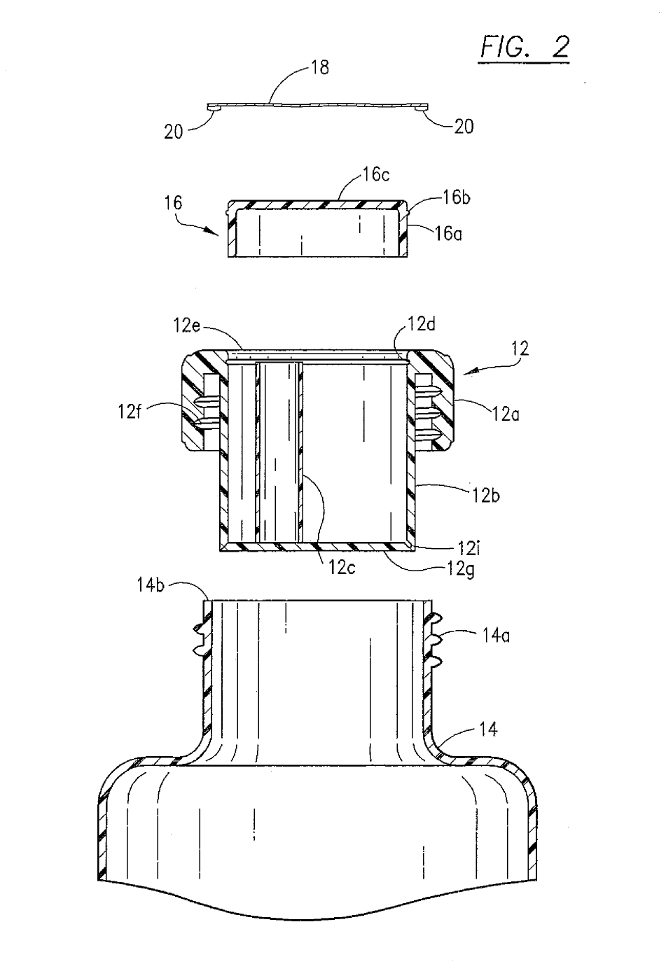

Referring now to FIG. 2, the cap body 12 which includes the storage chamber 12b which is cylindrical and the plunger 12c is shown. The plunger actuator body 16a has a top 16c that can be depressed manually after the actuator body 16a has been installed to fit as a top on the storage container 12b. The raised annular protrusion 12b which may be semi-circular fits snuggly in groove 12d in the closed position sealing the contents of the storage container 12b with a desirable liquid or powder that will be dispensed at the time of use.

The foil 18 may include a adhesive 20 that is used to seal the entire cap 12 and cover actuator 16 by attachment to cover the opening of cap body 12a along its top. The cap body 12 includes a plurality of thread grooves 12f that attach the entire cap 12 to a container such as bottle 14 that itself has threads 14a allowing the cap 12 to be sealably attached thereto.

At the factory, the cap storage chamber 12b is filled with a desired material that is to be dispensed through the floor 12g which includes a weakened area of opening 12i. Actuator 16 (once the foil 18 has been removed) can be depressed manually downwardly forcing actuator 12c downwardly ripping open a segment of the bottom wall 12g, allowing the material inside of the storage chamber 12b to be dispensed by gravity into bottle 14. Once the material has been dispensed into bottle 14, the entire cap body may be unscrewed and removed. The liquid that was originally in container 14 is now an admixture with the particular liquid or powder that was previously stored in the storage chamber 12b of cap 12. The admixture in bottle 14 can then be poured out through the opening 14b when desired.

One of the important aspects of the device shown in FIGS. 1 and 2 is that it provides a self-contained, small storage chamber that is molded unitarily with the bottle cap threaded connectors and bottle cap body itself. In addition, there is an opening in the top of the bottle cap body that allows the actuator to be sealably mounted therein. Finally, a thin film or foil seal can seal the entire top of the cap body.

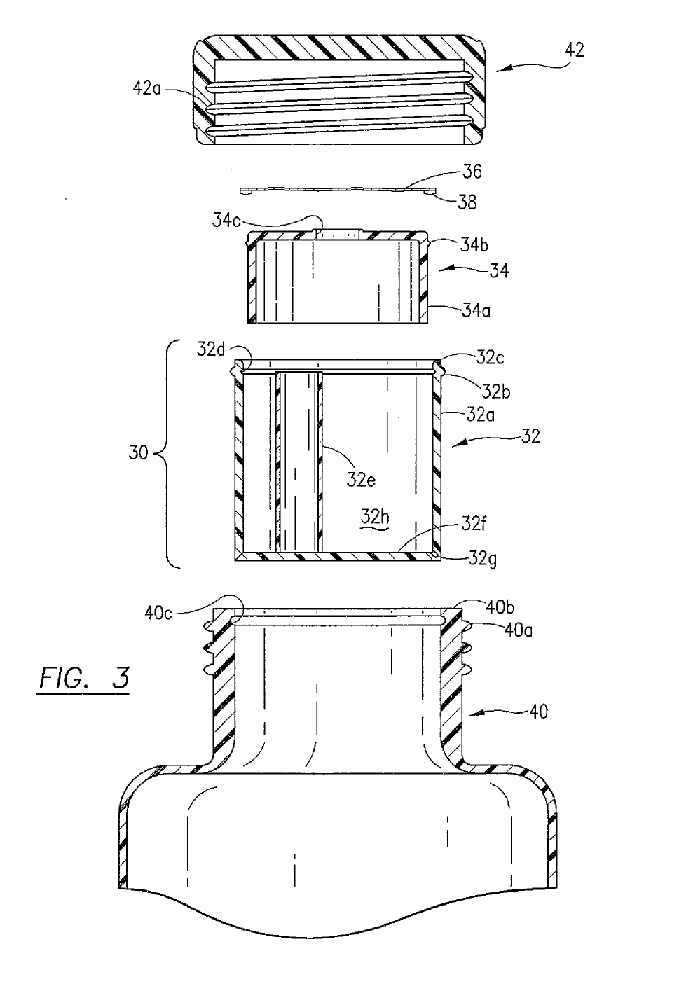

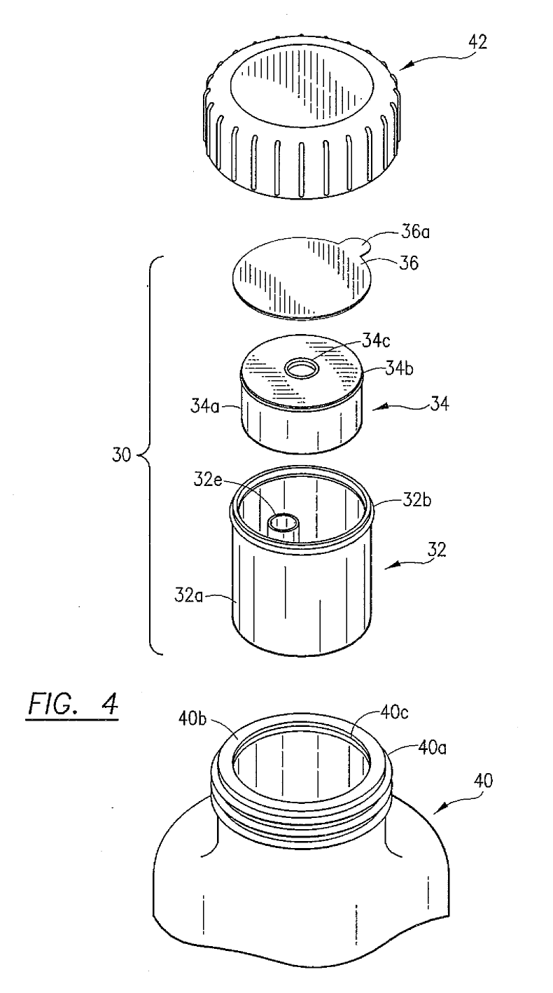

Referring now to FIGS. 3 and 4, a dispensing chamber is shown that is greatly improved for use with numerous types of bottle caps that permits storage chamber 32h to be filled with a liquid or powder through a hole 34c in the actuator 34. The actuator 34 fits snuggly inside of storage chamber 32h in the closed position.

The actuator 34 is cylindrically shaped and includes a cylindrical wall 34a that is preferably molded from a durable liquid-proof plastic that includes an annular raised bead or protrusion 34b that may be semi-circular in cross section disposed near its top for sealing the actuator inside the storage container 32. The purpose of the actuator body annular raised portion 34b is to seal the storage container compartment 32h when the actuator 32 has been positioned inside storage chamber 32h in a sealed closed position.

The actuator also has a circular hole or aperture 34c that is formed in the center of the actuator top 34. The actuator body hole or aperture or passageway 34c permits the filling of the storage chamber 32h even with the actuator 34 positioned inside chamber 32h.

In the preferred embodiment shown in FIG. 3, the dispensing chamber 32 is sealably mounted in the neck of primary container 40 that could be a plastic or paper bottle, bag, purch or receptacle, by an annular protrusion 32b that may be semi-circular in cross section configuration that fits sealably and snuggly in groove 40c. The sealing groove 40c is disposed near the container opening 40b at the top of the neck. The container neck also contains threads 40a that allow a container to be sealably closed by a conventional container cap 42 which also has threaded grooves 42a for closure.

A foil 36 is used to seal the dispensing chamber 32 and the actuator 34.

Having an air vent 34c in actuator 34 greatly expedites the filling procedure at the factory for dispensing chamber 32. Note that the entire unit is mounted flush in the bottle neck or the container neck 40 prior to use.

To operate the device, a user manually removes cap 42 from container 40. The user then depresses manually actuator 34 forcing the actuator downwardly against vertical plunger 32e that is integrally conformed with the receptacle 32 forcing floor 32f downwardly ripping the floor away along weakened portions 32g thus dispensing whatever materials, liquid or powder, that is contained within chamber 32h. The user would then remove foil 36 and has the option of either placing a straw through passage 34c for drinking the admixture contained in container 40 or pouring the liquid in container 40 out through passageway 34c for consumption.

Referring now to FIG. 4, the present invention is comprised of a receptacle body 32 that has a movably actuator 34 mounted therein and an air vent 34c which could be any shape and be vented at any portion along the top of actuator 34 all of which is sealed by foil 36 attached to the top of actuator 34. The entire dispenser receptacle 32 can be once filled physically mounted in the opening of container 40 where it is flush with the top of container 40 allowing a conventional cap 42 to be attached to container 40.

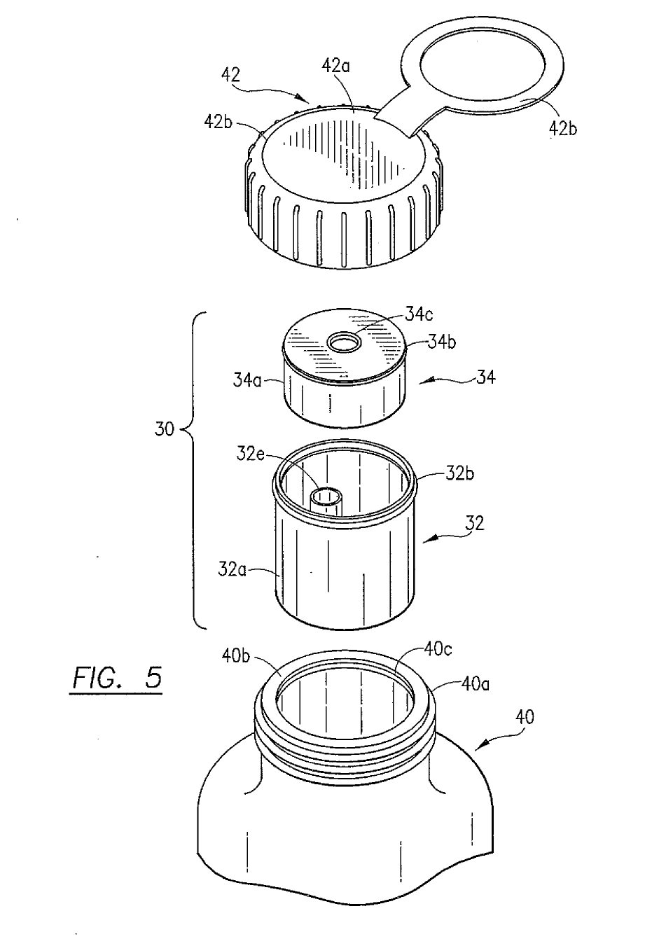

Referring now to FIG. 5, the alternate embodiment of the invention includes a cap that has a removable foil.

Referring now to FIG. 5, the embodiment shown in FIG. 4 has been modified with respect to cap 42 with the foil 36 being eliminated. In FIG. 5, the foiled seal cover is shown at 42a which can be disposed over cap 42 and include a finger ring for removing the seal foil 42a from the open cap 42 top allowing access to the straw/vent aperture 34c contained in the actuator 34. Thus, the cap 42 would have an aperture or opening 42b within which a sealed member which could be plastic, rubber or synthetic rubber or any other type of scaling foil 42a that seals the very top of cap 42. When ready for use, the finger ring 42b is pulled tearing away seal 42a.

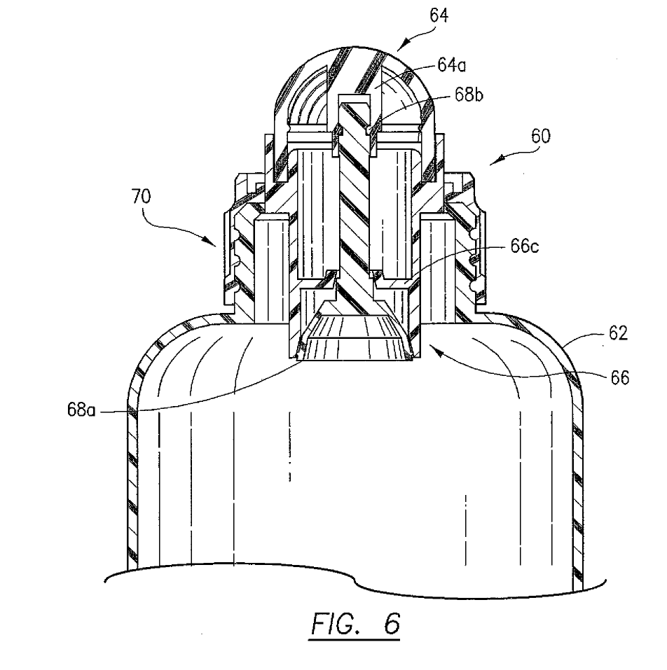

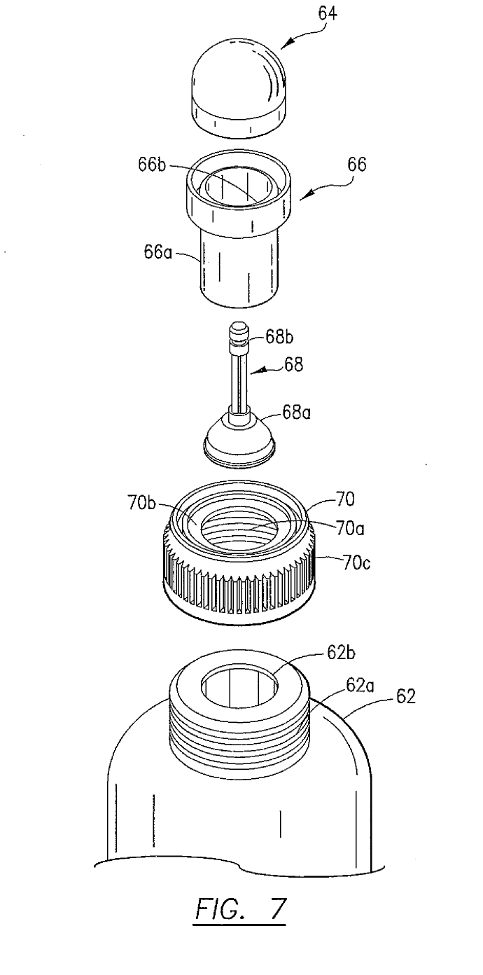

Referring now to FIGS. 6 and 7, another alternate embodiment of the invention is shown that provides for a storage chamber 66 that is a tube having an open bottom and an open top 66b. A rubber or synthetic rubber or plastic hemisphere 64 is flexible and resilient with memory and includes an inner chamber 64a that has a circular recess that engages the dispenser plunger 68 stem 68b locking the plunger 68 to the flexible actuator 64. Actuator 64 fits snuggly into an annular groove 66b mounted in the top of the storage chamber 66. The storage chamber 66 also includes a pair of guides 66c on the inside of the tube that acts to guide the plunger 68 and hold it in position in a closed position as shown in FIG. 6. The storage chamber 66 is filled with a material and then the plunger 68 is snapped into place with the storage chamber upside down so that the material does not spill out until the plunger is in place. The resilient hemisphere actuator 64 holds the plunger base 68a against the inside wall of storage chamber 66 as shown in FIG. 6 in a storage position. The entire storage chamber may be mounted within a bottle cap 70 that includes threads 70a that allows attachment of the entire unit to a bottle 62 using the threaded fasteners 62a, all of which is mounted through aperture or opening 62b in bottle 62.

FIG. 6 shows the closed storage position such that the storage container 66 would contain a liquid or powder that can be easily dispensed into bottle 62 merely by manually pushing downwardly against the flexible actuator 64 which causes plunger 68 to move downwardly allowing the conical truncated base 68a of plunger 68 to be separated from the annular opening at the bottom of storage chamber 66 causing the material inside to be dispensed downwardly by gravity into bottle 62. Notice that the resilient actuator 64 acts like a spring and once manual pressure is released, the entire plunger will move upwardly due to the force caused by the hemisphere actuator upwardly.

The entire dispensing cap and unit can be attached to bottle 62 at the factory using cap 70 into which is mounted the storage chamber 66, the actuator 64 and plunger 68. Once a substance has been dispensed into bottle 62, the entire cap may be removed now that the substances in bottle 62 has been mixed with whatever was in the cap dispenser and the contents can then be poured out of the bottle 62 or consumed from the bottle.

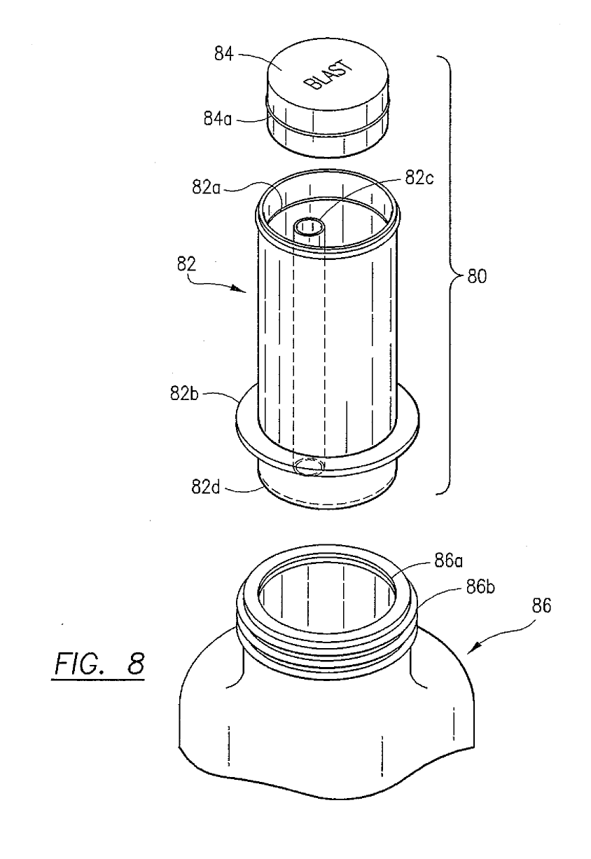

Referring now to FIG. 8, an alternate embodiment of the invention is shown that includes a storage compartment or chamber 80 that would hold a second substance for mixture with a first substance in primary container 86 which is a bottle, pouch, bag, can or any other type of liquid container. In FIG. 8, the bottle 86 has had its cap removed and is not shown which is a threaded conventional fastener for covering bottle 86. The storage container 80 includes an actuator 84 which is cylindrical and which fits into the open top 82a of chamber 82 which is a long cylinder having a closed sealed bottom 82d and a support rim that is annular 82b that is sized to extend over the top edge of the opening 86a in bottle 86.

The device 80 shown in FIG. 8 is thus used to dispense a second substance, powder or liquid housed within storage chamber 80 at the time of use. In order to use the device shown in FIG. 8, the storage chamber 82 is mounted over the opening 86a and inserted therein so that the rim 82b of chamber 82 rests firmly on top of the bottle opening 86a. With this support, the user can push downwardly on the actuator 84 engaging a vertical plunger 86c connected firmly to the bottom floor of storage chamber 82, the floor being 82d. The floor may have a weakened portion but still be sealed that when pushed downwardly by plunger 82c rips away dispensing the contents in chamber 82 into bottle 86. Once emptied, device 80 can then be just discarded and the original bottle cap restored over the threads 86b.

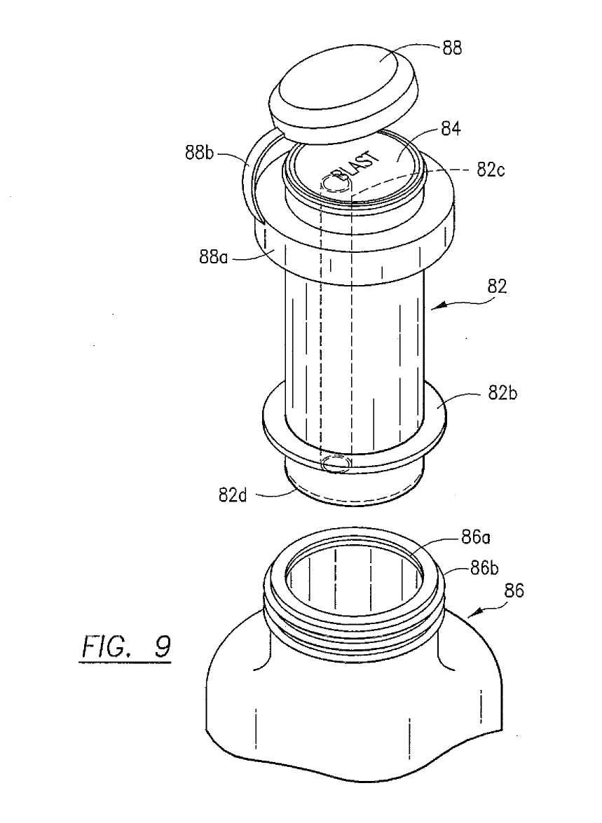

FIG. 9 shows a similar device of that shown in FIG. 8 with the addition that the storage chamber may have a threaded annular member 88a that can screw into the top of bottle 86 or be used strictly as a mount for a pop sealed cap 88 that fits over the actuator 84 sealing the top of storage chamber 82 until ready for use. The snap on cap or cover 88 is attached to rim 88a by a strap 88b which can all be made of molded plastic. Thus, cover 88 acts as a seal until ready for use for the materials or substance stored in container or chamber 82. The annular rim 82b would be smaller than bottle opening 86 for the threaded cap 88a or could be used with small diameter bottles individually without the screw cap.

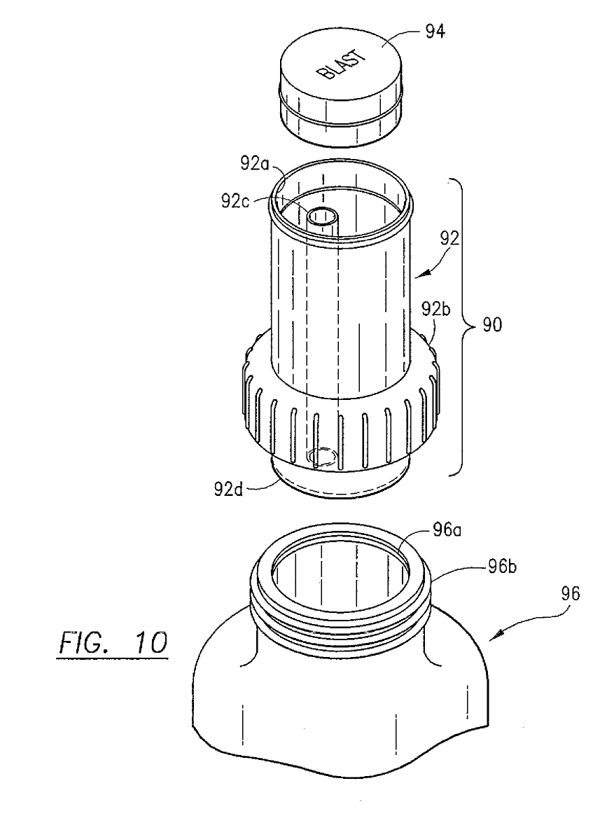

FIG. 10 shows a similar device of that shown in FIGS. 8 and 9 except that near the bottom of the storage container 92 is mounted a bottle top fastener having a molded threaded annular ring 92b with the threads on the inside annular wall that engage the threads 96b of bottle 96 for securely fastening the storage chamber 92 to bottle 96 when not in use and sealing bottle 96. The bottom of storage container 92d has lines of weakening and a portion breaks away by downward force on the vertical plunger 92c by pushing downward on actuator 94 which fits snuggly inside the opening of storage chamber 92. Thus, in operation, the device in FIG. 10 can dispense a substance stored in container 92 into bottle 96. When the actuator 94 is manually depressed tearing away bottle bottom 92d of storage container 92 dispensing material into bottle 96. Once the storage container is removed from bottle 96 and the contents exploded, the container 90 can be discarded.

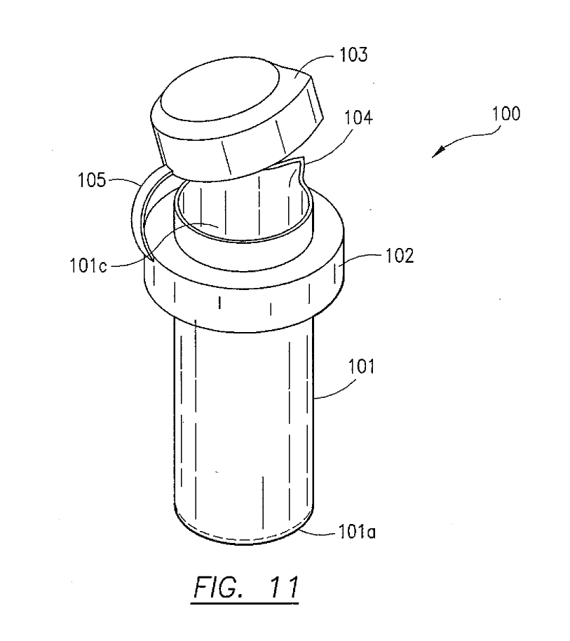

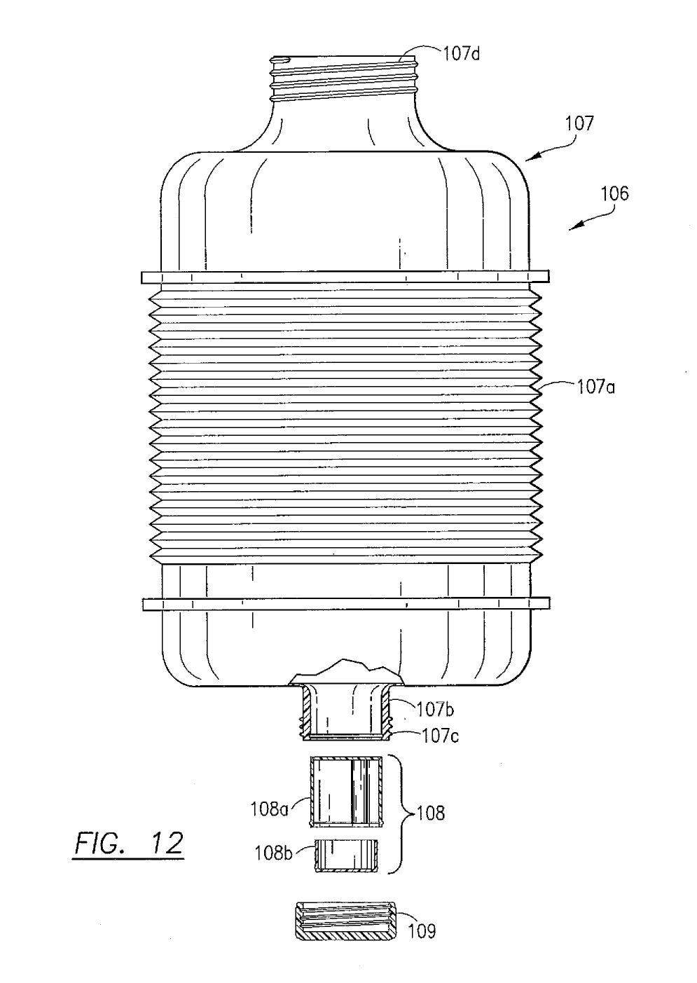

Referring now to FIG. 11, a different type of dispensing container or storage container is shown at 100. This is an elongated cylindrical chamber 101 with a solid base bottom 101a and a rim 102 that can be screwed onto the neck of a bottle for mounting it as a bottle cap. A flip top 103 connected by tab 105 covers the contents 101c which can be contained with a liquid or powder to be dispensed into the bottle. The container 100 includes a pour spout which is “V-shaped” 104 that allows any of the materials, liquid or powder to be easily poured into the bottle. Thus, in operation, the storage container 100 does not have a tear away bottom but has a solid bottom 101a. To use the device, the entire cap and container 100 are removed from the top of the bottle and the flip top cap 103 is opened, and then the contents is poured directly into the bottle. The storage container 100 can still be utilized as a bottle cap or can be discarded.

Referring now to FIG. 12, another embodiment of the invention is shown in which the container 107 is somewhat cylindrical at each end and includes a first bottle neck 107d that receives a conventional cap (not shown) and a second lower small in diameter bottle neck 107b that includes threads 107c for attaching conventional cap 109 thereto. Inserted within the bottle 107b is a storage container 108 that includes the storage container with a bottom that can be broken away and a plunger 108b that can be used to dispense the fluid as shown in the prior devices such as in FIG. 1 with the collapsible bottom. In this particular embodiment, the regular bottle cap 107d can remain intact while, at the same time, the storage cap 108 will be firmly positioned within the container 107 until ready for dispensing. Once the storage cap 108 and its contents have been dispensed into container 107, the storage container 108 can be discarded and the cap 109 replaced over bottle neck 107b with the mixture of the initial liquid and the substance disposed in and removed from storage container 108. The entire device 106 which includes storage container 108 and the accordion body portion 107a allows the entire unit to be shipped in a folded condition until it is ready to be filled at the factory.

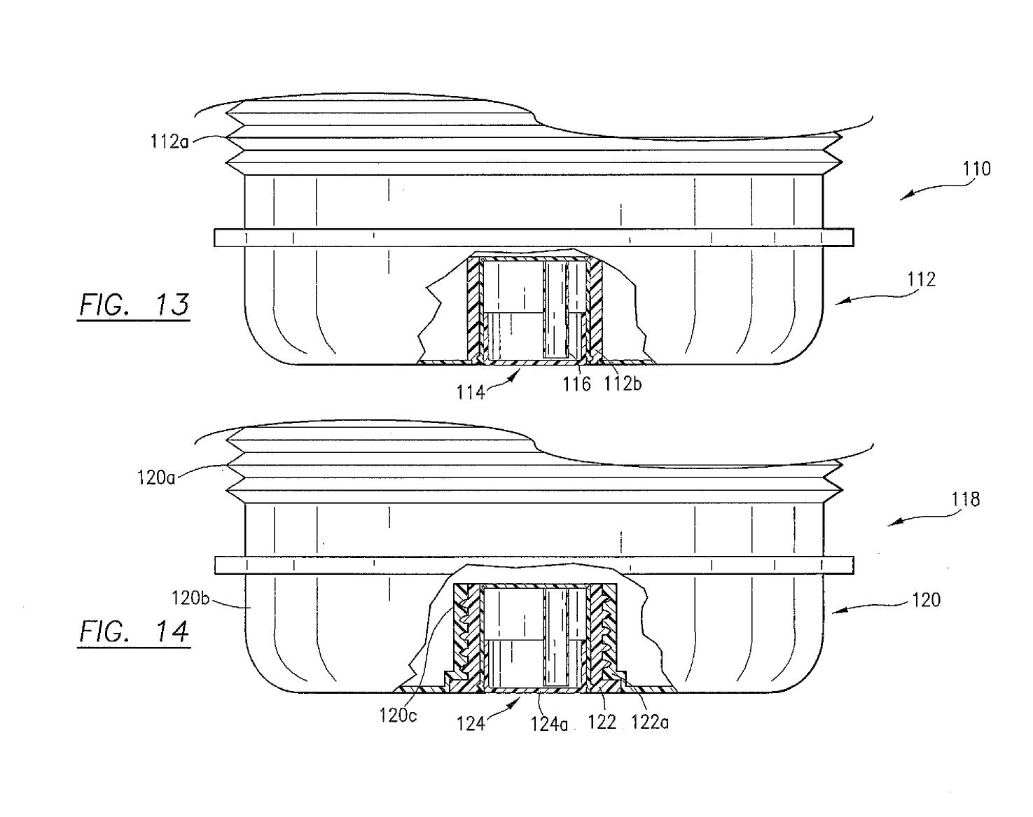

Referring now to FIG. 14, an alternate embodiment of that shown in FIG. 12 is shown that includes the storage container 124 similar to one shown in FIG. 1 that has a plunger that also includes a sleeve 122 that is threaded on the outside with threads 122a that engage a threaded cylinder 120c that is part of the wall of container 120. This means that storage container 124 can be threadably inserted and sealed in the base of container 120 by engaging the threaded wall 120c of container 120. The accordion wall 120a is similar as described above. Thus, to operate the device shown in FIG. 14, the plunger 124a is depressed tearing away the bottom 124b dispensing the material within the storage container 124a into container 120.

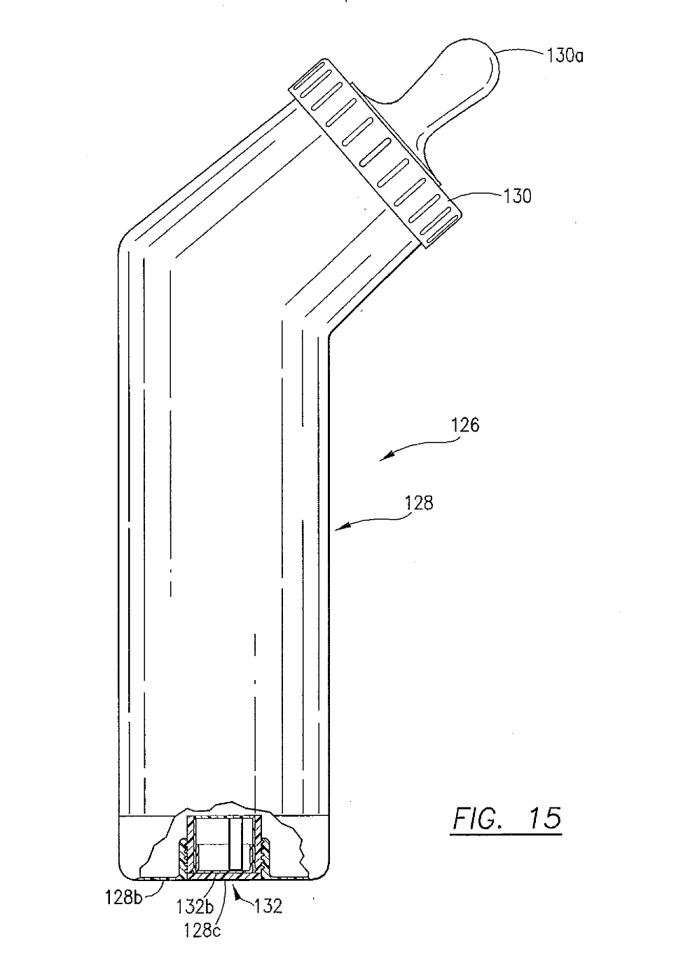

Referring now to FIG. 15, a baby bottle 126 is shown having a typical top that includes a nipple 130a and a cylindrical body 128. The base of the baby bottle 128 includes a cylindrical threaded portion 128a that can receive a storage container 132 that is threadably inserted into the base 128b by threads 132a on the outside of the storage container 132. The upper cap 132b can be depressed against the plunger tearing away the floor dispensing whatever contents, liquid or powder, is in the storage container 132 into the baby bottle 128. The storage container when mounted in the base 128b is sealed so that no liquid in the baby bottle 128 can leak out the bottom. The outer most wall 128c is flexible enough to allow depression of the dispensing cap 132b so that the plunger is activated but the bottom base wall 128b is not punctured or open so that no liquid can drain out of the baby bottle 15.

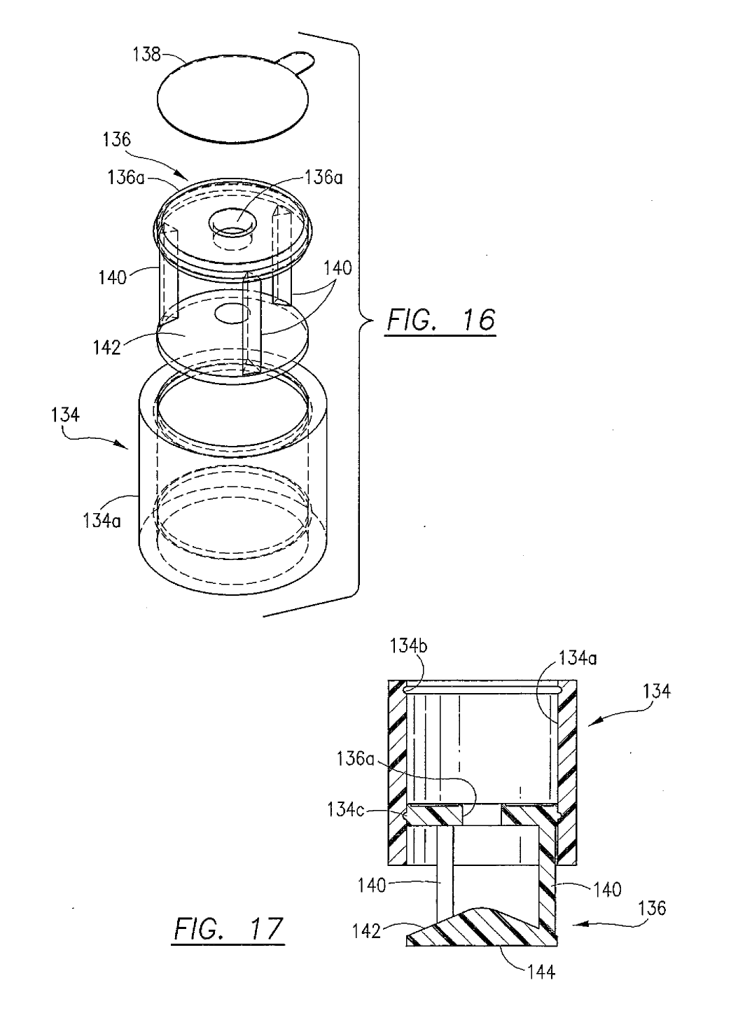

Referring now to FIG. 16, a dispensing capsule 134 is shown that includes a cylindrical body 134a that may be made of hard plastic or any other material that is basically an open tube. The center plunger 136 includes a top wall 136a that is disc-shaped that has a hole or aperture 136a that is covered by a foil or plastic seal cap 138 that can be removed. The bottom of the plunger includes a conical shaped wall 142 that rises in the center and slopes outwardly from the center to the outside annular ring of the base 142. Three side walls 140 connect the upper top disc 136a parallel to the bottom disc wall 142 that is sloped. The outside diameter of the plunger 136 inner compartment is snuggly sized to fit inside of the storage container cylinder 134 as shown in FIG. 17. Note that the inside circular wall of storage container 134 includes a pair of annular recesses 134b and 134c, each of which engage nipples to activate the device in FIGS. 16 and 17. First of all, the storage container 134 may be filled at the factory through cap opening 136a before the sealed cover 138 is glued to cap 136. Notice that the recesses 134c and 134b which are annular rings around the inside wall of the storage container 134 cylinder are used to hold the inside plunger in its stored position with the cap 136 aligned with recess 134b. When the device is activated which may be mounted inside the neck of a bottle as shown in the many embodiments in this invention, the cap 136a is depressed exposing the open spaces between side post 140 to the interior of the bottle allowing the contents to be dumped into the container. The purpose of the inclined surface on base 142 is to aid in the dispensing of the product, liquid or powder, draining downwardly by gravity.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A primary container cap that includes a dispensing storage chamber for an ingredient that can be released into the primary container at time of use activation comprising:
a threaded container cap for engaging and enclosing a primary container having a threaded neck, said threaded container cap including a storage compartment body having a first opening and a second opening and integrally formed with said threaded container cap, said threaded container cap having a central passage opening in communication with said compartment body first opening;
a bottom closure for sealing the second opening forming the bottom of said storage compartment body, said bottom closure including a line of weakening between the closure and said storage compartment body, said bottom storage compartment closure having a top inside surface;
a rigid vertical plunger connected at one end to the top inside surface of said storage compartment body bottom closure; and
a movable closure mounted over said first open end of said storage compartment body for closing said storage compartment first open end, said storage compartment body thus including a sealed storage compartment that includes the bottom closure and said top movable closure in the closed storage position, said top movable closure sized to move inside said storage container body and engage said vertical plunger, said movable closure forming a snug fit on the inside of said storage compartment body for closing but allowing movement so that said movable closure can be depressed downwardly forcing said plunger downwardly and tearing open said bottom closure allowing the contents in said storage compartment body to be dispensed into said primary container.

2. A dispensing container cap for time of use activation for storing an ingredient to be dispensed into a primary container such as a bottle comprising:
a threaded container cap for enclosing a primary container;
a cylindrical storage compartment integrally connected to said container cap; and
means connected to said storage compartment for enclosing and storing an ingredient inside said storage compartment in a first storage position and movable to a second position dispensing any materials within said storage compartment through the bottom of said storage compartment.

3. A dispensing container cap as in claim 2, including:
said storage compartment body including a movable bottom closure, said movable bottom closure including a plurality of longitudinal frame members for mounting said movable bottom closure movably inside said storage container in a first closed position and in a second open position where said bottom closure is moved downwardly away from said storage compartment walls thus exposing the open sides of said bottom closure for dispensing ingredients inside said storage compartment.

4. A container storage cap as in claim 2, including:
a rigid cylindrical compartment wall having an open top and an open bottom;
a frangible bottom wall sealably attached to the bottom opening of said cylindrical compartment sealing said compartment in a first storage position.

5. A container cap as in claim 2, including:
a removable seal attached to and across the top of opening of said container cap for sealing said container cap at the top, said removable seal including a tab for removal manually.

6. A container cap as in claim 2, including:
said storage compartment bottom closure including a conically-shaped disk for sealing said bottom closure in a closed position and being totally removable in the open position for dispensing ingredients in said storage compartment.

7. A device as in claim 2, wherein:
said storage compartment body is cylindrical and extends above said cap threaded rim providing an extended compartment that rises well above the cap threaded members of the primary bottle cap for increased storage of the ingredient to be dispensed.

8. A dispensing cap for storing a substance to be dispensed at the time of use into a bottle or a primary container for admixing two substances to preserve shelf life until the time of use comprising:
a tubular storage chamber for a substance having an open first end and an open second end, said open first end including an annular axial lip facing upwardly;
a hemispherically shaped resilient plastic actuator that includes a central passage for fastening and receiving a plunger, said actuator attachable to said storage chamber annular lip;
a plunger having a shaft, said shaft having a first end that includes a truncated conical body disposed outwardly from said plunger shaft and a second end including a groove sized to be attached to said actuator passage for connecting the plunger at one end to the actuator;
a threaded annular bottle cap having an annular rim and an interior aperture sized for connecting said storage chamber inside said bottle cap; and
said storage chamber having said plunger mounted therein in a first storage position closing the bottom of said storage chamber and resilient spring action from said actuator for holding a material inside said storage chamber in said storage position and a second manually activated position wherein said plunger base by manual actuation of said actuator opens the bottom of said storage chamber allowing the contents to be dispensed.

9. A device as in claim 8, wherein:
said primary container is a pouch.

10. A device as in claim 8, wherein:
said top actuator is a hemispherically shaped flexible plastic or rubber cap that includes an interior passage for receiving said plunger shaft.

11. A device as in claim 8, wherein:
said bottom sealed closure is substantially a truncated cone that connects to the plunger shaft.

12. A dispensing capsule for storing an ingredient separately that is integrally attached to a primary container, said storage compartment and the primary container comprising:
a primary container having a first opening for dispensing the internal contents, said first opening including a threaded neck;
a primary cap that includes threads for enclosing said primary opening of said primary container;
said primary container body including a recessed threaded passage that includes a second internally threaded passage and opening into said primary container;
an ingredient storage capsule having a frangible sealed base and an open top and a cylindrical wall for storing a second ingredient, said capsule sized to fit within the second passage and opening in said primary container;
a plunger attached to the bottom closure of said ingredient storage container;
an actuating cover sealably attachable to the open end of said second storage chamber and engagable with said plunger, said actuating cover being disposed inside said storage chamber and movable to activate said plunger to tear away said bottom closure in said storage chamber for dispensing the ingredient in said storage chamber; and
a second threaded cap engageable with said primary storage container for closing said second opening in said primary container body having a threaded opening.

13. A device as in claim 12, including:
said primary storage container including a plurality of accordion body folds along its wall that allows the primary container to be collapsed and folded in a smaller configuration for shipping.

14. A device as in claim 12, including:
said primary storage container being a baby bottle that includes at its primary open end a removable cap that includes a nipple for activation by a baby.

15. A device as in claim 12, wherein:
said primary container is a pouch.

16. A device as in claim 12, wherein:
said primary container is a plastic liquid container.
